(19) United States
(12) Patent Application Publication
(10) Pub. No.: US 2016/0314252 A1
(43) Pub. Date: Oct. 27, 2016

(54) METHOD AND SYSTEM FOR HEALTH INSURANCE ENROLLMENT

(71) Applicant: James Anderson, Palmetto Bay, FL (US)

(72) Inventor: James Anderson, Palmetto Bay, FL (US)

(21) Appl. No.: 14/693,580

(22) Filed: Apr. 22, 2015

Related U.S. Application Data
(60) Provisional application No. 62/150,657, filed on Apr. 21, 2015.

(51) Int. Cl. G06F 19/00

(52) U.S. Cl. CPC G06F 19/328

(57) ABSTRACT

A software application for a mobile device, and an associated computer network system, are provided for securely enrolling individuals in programs such as a health insurance policies. Enrollment information may be collected in the field and securely transmitted to a local area network for decryption, and then to a cloud computer system for secure storage. A second local area network, operated by an administrator, may access the decrypted enrollment information from the cloud computer system, process the enrollment information, and transmit the processed enrollment information to a third party for complete the enrollment process.

### CROSS REFERENCE TO RELATED APPLICATIONS

This application claims the benefit of U.S. Provisional Application No. 61/982,550 filed on Apr. 22, 2014 and U.S. Provisional Application No. 62/150,657 filed on Apr. 21, 2015, the disclosures of which are herein incorporated by reference in their entirety.

### FIELD OF THE DISCLOSURE

This disclosure relates generally to software applications and a system for enrolling individuals in programs or services and, more particularly, health care programs.

### BACKGROUND

Health insurance has been a forefront concern for the United States and its health care policy. Prior to passing the Patient Protection and Affordable Care Act in 2010, the United States federal government's Medicaid and Medicare programs accounted for approximately half of all national health spending. Enrollment in these programs, however, can be a difficult and cumbersome process. One example is Medicare Part D, which provides prescription drug coverage for Medicare eligible enrollees, whose enrollment involves a multi-step paper process often requiring numerous follow up visits and appointments to complete the enrollment. This process is subject to fraud, particularly by field agents collecting sensitive personal information from enrollees at their homes or place of business. Significant human error is also prevalent, particularly where the process requires multiple follow up visits after verification of personal data and confirmation of eligibility for various plans. While Medicare Part D is a notable example, the challenges of fraud and error are not unique to this program. Both government and non-government program enrollments would benefit from a more secure and efficient enrollment process.

Enrolling individuals in insurance programs can also be particularly challenging for field agents. An agent's recommendation for an enrollee's insurance program may change depending on the data the agent may collect from the enrollee. For instance, some insurance programs are only available for certain geographical areas. An agent may travel a very short distance, changing zip codes in the process, resulting in difference in programs or policies available to individuals in the new location. Similarly, an agent may not always appreciate what the preferred program or policy would be for a potential enrollee depending on their personal attributes. The potential enrollee's best available plan may change once the agent learns of certain personal attributes, such as the enrollee's age or whether the enrollee is a smoker.

### BRIEF SUMMARY OF THE DISCLOSURE

The following presents a simplified summary of the disclosure in order to provide a basic understanding of some aspects of the invention. This summary is not an extensive overview of every embodiment disclosed herein. It is intended to neither identify key or critical elements of the various embodiments nor delineate the scope of the disclosure. Its sole purpose is to present some concepts of the disclosure, in accordance with the various embodiments disclosed herein, in a simplified form as a prelude to the more detailed description that is presented later.

In one embodiment of the disclosure, a system for enrolling individuals in an insurance policy may include a mobile device for collecting, transmitting, and encrypting enrollment information, a local area network for receiving and decrypting enrollment information, a cloud computer system for receiving and storing the decrypted enrollment information, and an additional local area network for processing the enrollment information.

The following description and the annexed drawings set forth certain illustrative aspects of the embodiments of the disclosure. These aspects are indicative, however, of but a few of the various ways in which the principles of the disclosure may be employed and the various embodiments are intended to include all such aspects and their equivalents. Other advantages and novel features will become apparent from the following description when considered in conjunction with the drawings.

### BRIEF DESCRIPTION OF THE FIGURES

FIGS. 1 and 2 illustrate block diagrams of an embodiment of a portable multifunction device with touch-sensitive displays

FIG. 3 illustrates an embodiment of a graphical user interface as part of an embodiment of a computer software application operating on a mobile device, the interface showing a home screen;

FIG. 4 illustrates an embodiment of a graphical user interface as part of an embodiment of a computer software application operating on a mobile device, the interface showing an enrollee personal information collection screen;

FIG. 5 illustrates an embodiment of a graphical user interface as part of an embodiment of a computer software application operating on a mobile device, the interface showing an enrollee medical information collection screen;

FIG. 6 illustrates an embodiment of a graphical user interface as part of an embodiment of a computer software application operating on a mobile device, the interface showing an enrollee additional information collection screen;

FIG. 7 illustrates an embodiment of a graphical user interface as part of an embodiment of a computer software application operating on a mobile device, the interface showing a continuation of an enrollee additional information collection screen;

FIG. 8 illustrates an embodiment of a graphical user interface as part of an embodiment of a computer software application operating on a mobile device, the interface showing a plan information selection and assistance screen;

FIG. 9 illustrates an embodiment of a graphical user interface as part of an embodiment of a computer software application operating on a mobile device, the interface showing a continuation of a plan information selection and assistance screen;

FIG. 10 illustrates an embodiment of a graphical user interface as part of an embodiment of a computer software application operating on a mobile device, the interface showing a signature or confirmation screen;

FIG. 11 illustrates an embodiment of a graphical user interface as part of an embodiment of a computer software application operating on a mobile device, the interface showing a continuation of a signature or confirmation screen;

FIG. 12 illustrates an embodiment of a graphical user interface as part of an embodiment of a computer software application operating on an administrative computer, the interface showing a collected personal information screen;

FIG. 13 illustrates an embodiment of a graphical user interface as part of an embodiment of a computer software application operating on an administrative computer, the interface showing a collected medical information screen;

FIG. 14 illustrates an embodiment of a graphical user interface as part of an embodiment of a computer software application operating on an administrative computer, the interface showing a collected personal information screen; and

FIG. 15 illustrates a schematic of system architecture in accordance with an embodiment of the disclosure.

### DETAILED DESCRIPTION

The following detailed description and the appended drawings describe and illustrate some embodiments of the disclosure for the purpose of enabling one of ordinary skill in the relevant art to make and use these embodiments. As such, the detailed description and illustration of these embodiments are purely illustrative in nature and are in no way intended to limit the scope of the disclosure in any manner. It should also be understood that the drawings are not necessarily to scale and in certain instances details may have been omitted, which are not necessary for an understanding of the embodiments, such as details of fabrication and assembly. In the accompanying drawings, like numerals represent like components.

Embodiments of applications executed by portable multifunction devices, user interfaces for such devices, and associated processes for using such devices are described. In some embodiments, the device is a portable communications device such as a mobile telephone that also contains other functions, such as PDA and/or music player functions.

For simplicity, in the discussion that follows, a prior art portable multifunction device that includes a touch screen is used as an exemplary embodiment for executing the applications of the present invention. A prior art portable multifunction device such as an iPhone™ or the device disclosed in U.S. Pat. No. 7,479,949 can be used to execute the applications of the present invention. The applications can also be executed in portable multifunction devices that do not include a touch screen for inputting information, but that rely instead on a more conventional mechanism, for example point-and-click, keypad, keyboard, or click-wheel mechanisms.

In addition to supporting the applications of the present disclosure, the portable multifunction device described below can support a variety of applications, such as one or more of the following: a telephone application, a video conferencing application, an e-mail application, an instant messaging application, a blogging application, a photo management application, a digital camera application, a digital video camera application, a web browsing application, a digital music player application, and/or a digital video player application.

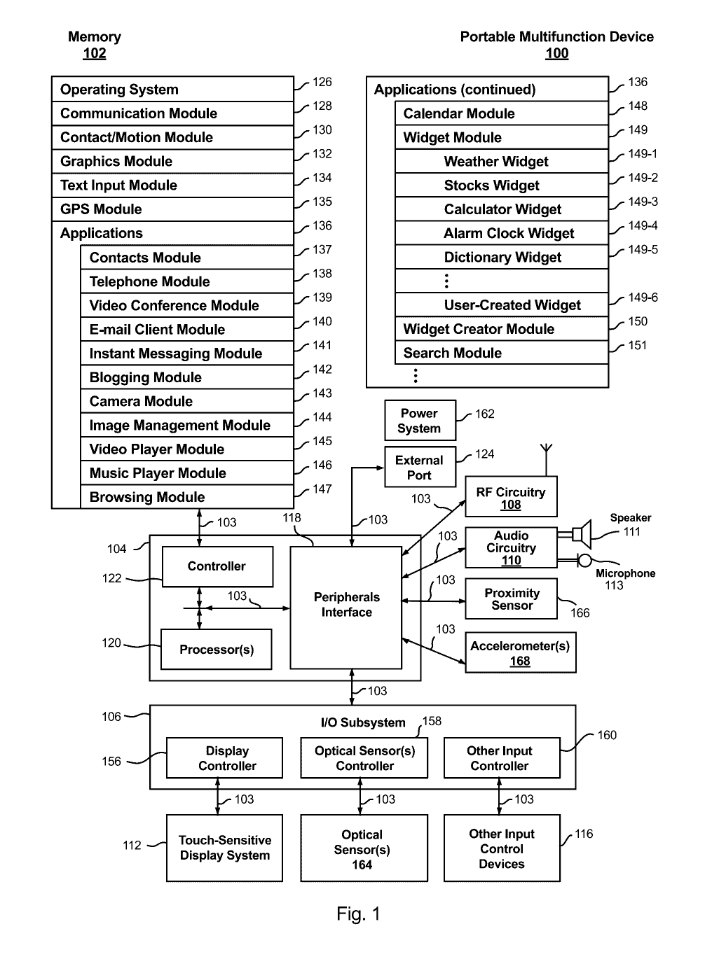

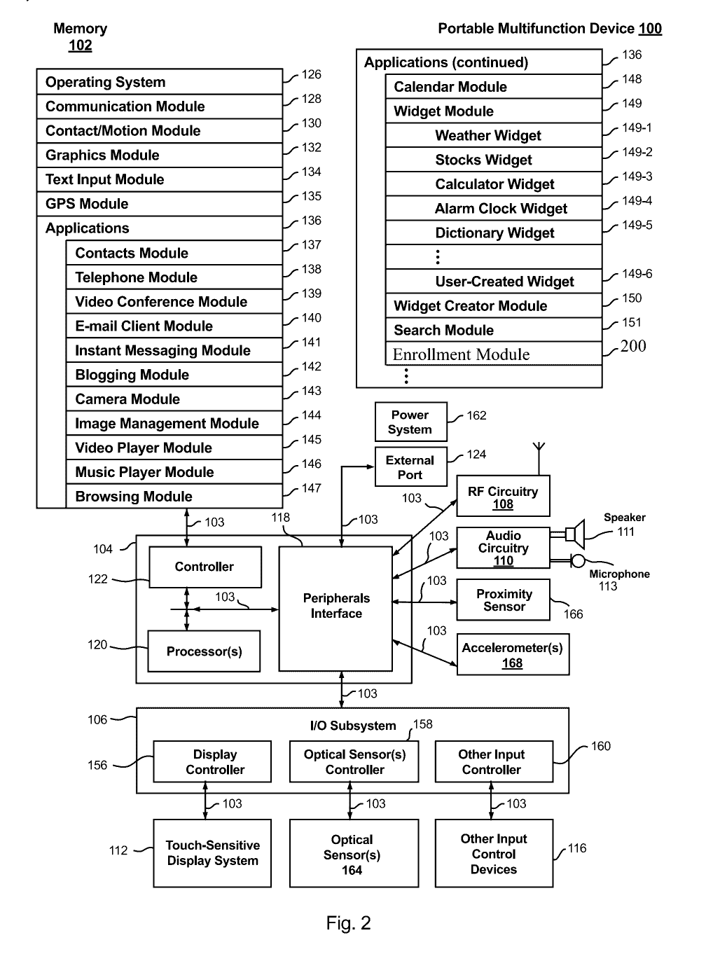

FIGS. 1 and 2 are block diagrams illustrating exemplary prior art portable multifunction devices 100 with touch-sensitive displays 112 modified to include the applications of the present invention. The touch-sensitive display 112 is also known in the art as a touch screen or a touch-sensitive display system. The device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. The device 100 may include one or more optical sensors 164. These components may communicate over one or more communication buses or signal lines 103.

The device 100 is only one example of a portable multifunction device 100 that may be used to execute the applications of the present disclosure, and that the device 100 may have more or fewer components than shown, may combine two or more components, or a may have a different configuration or arrangement of the components. The various components shown in FIGS. 1 and 2 may be implemented in hardware, software or a combination of both hardware and software, including one or more digital signal processing (“DSP”) circuits and/or application specific integrated circuits (“ASICs”).

Memory 102 may include high-speed random access memory and may also include non-volatile memory, such as one or more magnetic disk storage devices, flash memory devices, or other non-volatile solid-state memory devices. Access to memory 102 by other components of the device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the device 100 and to process data.

The peripherals interface 118, the CPU 120, and the memory controller 122 may be implemented on a single chip, such as a chip 104. They may also be implemented on separate chips.

The transceiver circuitry 108 receives and sends electromagnetic signals. A person of ordinary skill in the art would recognize that these signals are conventionally referred to as radio frequency (“RF”) signals in the context of portable devices, regardless of whether the signals fall within what is conventionally known as the radio spectrum. The term transceiver circuitry and RF circuitry will be used interchangeably in the present application.

The RF circuitry 108 converts electrical signals to/from electromagnetic signals and communicates information to and from communications networks and other communications devices by modulating/demodulating electromagnetic signals with data corresponding to the information. The RF circuitry 108 may include circuitry known in the art for performing these functions, including but not limited to an antenna system, one or more amplifiers, filters, a tuner, one or more oscillators, a digital signal processor, a CODEC chipset, modulator/demodulator, a subscriber identity module (SIM) card, memory, and so forth. The RF circuitry 108 may communicate with networks, such as the Internet, an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS)), and/or Short Message Service (SMS)), or any other suitable communication protocol, including communication protocols not yet developed as of the filing date of this application.

The audio circuitry 110, the speaker 111, and the microphone 113 provide an audio interface between a user and the device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. The audio circuitry 110 may also include a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the device 100, such as the touch screen 112 and other input/control devices 116, to the peripherals interface 118. The I/O subsystem 106 may include a display controller 156 and one or more input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. Input controller(s) 160 may also be coupled to any (or none) of the following: a keyboard, infrared port, USB port, and a pointer device such as a mouse.

The touch-sensitive touch screen 112 provides an input interface and an output interface between the device and a user. The display controller 156 receives and/or sends electrical signals from/to the touch screen 112. The touch screen 112 displays visual output to the user. The visual output may include graphics, text, icons, video, and any combination thereof (collectively termed “graphics”).

A touch screen 112 has a touch-sensitive surface, sensor or set of sensors that accepts input from the user through tactile contact. The touch screen 112 and the display controller 156 (along with any associated modules and/or sets of instructions in memory 102) detect contact (and any movement or breaking of the contact) on the touch screen 112 and converts the detected contact into interaction with user-interface objects (e.g., one or more soft keys, icons, web pages or images) that are displayed on the touch screen. For example, a point of contact between a touch screen 112 and the user corresponds to a finger of the user.

The touch screen 112 may use LCD (liquid crystal display) technology, or LPD (light emitting polymer display) technology, although other display technologies may also be used. The touch screen 112 and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen 112.

The device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The device 100 may also include one or more optical sensors 164. FIGS. 1 and 2 show an optical sensor coupled to an optical sensor controller 158 in I/O subsystem 106. The optical sensor 164 may include charge-coupled device (CCD) or complementary metal-oxide semiconductor (CMOS) phototransistors. The optical sensor 164 receives light from the environment, projected through one or more lens, and converts the light to data representing an image. In conjunction with an imaging module 143 (also called a camera module), the optical sensor 164 may capture still images or video. The optical sensor may be located on the back of the device 100, opposite the touch screen display 112 on the front of the device, so that the touch screen display may be used as a viewfinder for either still and/or video image acquisition. An optical sensor may also be located on the front of the device so that the user's image may be obtained for videoconferencing while the user views the other video conference participants on the touch screen display. Preferably, the position of the optical sensor 164 can be changed by the user (e.g., by rotating the lens and the sensor in the device housing) so that a single optical sensor 164 may be used along with the touch screen display for both video conferencing and still and/or video image acquisition.

The device 100 may also include one or more proximity sensors 166. FIGS. 1 and 2 show a proximity sensor 166 coupled to the peripherals interface 118. Alternately, the proximity sensor 166 may be coupled to an input controller 160 in the I/O subsystem 106. The proximity sensor 166 may be used to turn off and disable the touch screen 112 when the multifunction device is placed near the user's ear (e.g., when the user is making a phone call). The proximity sensor can also be used to keep the screen off when the device is in the user's pocket, purse, or other dark area to prevent unnecessary battery drainage when the device is a locked state.

The device 100 may also include one or more accelerometers 168. FIGS. 1 and 2 show an accelerometer 168 coupled to the peripherals interface 118. Alternately, the accelerometer 168 may be coupled to an input controller 160 in the I/O subsystem 106. The accelerometer 168 captures data that is analyzed to determine whether to change a view of information, for example from portrait to landscape, displayed on the screen of the portable device.

The software components stored in memory 102 may include an operating system 126, a communication module (or set of instructions) 128, a contact/motion module (or set of instructions) 130, a graphics module (or set of instructions) 132, a text input module (or set of instructions) 134, a Global Positioning System (GPS) module (or set of instructions) 135, and applications (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, an internal clock, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.).]

The contact/motion module 130 may detect contact with the touch screen 112 (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen 112, and determining if the contact has been broken (i.e., if the contact has ceased). Determining movement of the point of contact may include determining speed (magnitude), velocity (magnitude and direction), and/or an acceleration (a change in magnitude and/or direction) of the point of contact. These operations may be applied to single contacts (e.g., one finger contacts) or to multiple simultaneous contacts (e.g., “multitouch”/multiple finger contacts). Alternatively the contact/motion module 130 and the controller 160 detect contact on a click wheel, for example.

The graphics module 132 includes various known software components for rendering and displaying graphics on the touch screen 112, including components for changing the intensity of graphics that are displayed. As used herein, the term “graphics” includes any object that can be displayed to a user, including without limitation text, web pages, icons (such as user-interface objects including soft keys), digital images, videos, animations and the like.

The text input module 134, which may be a component of graphics module 132, provides soft keyboards for entering text in various applications (e.g., contacts 137, e-mail 140, IM 141, blogging 142, browser 147, and any other application that needs text input).

The GPS module 135 determines the location of the device and provides this information for use in various applications (e.g., to telephone 138 for use in location-based dialing, to camera 143 and/or blogger 142 as picture/video metadata, and to applications that provide location-based services such as weather widgets, local yellow page widgets, and map/navigation widgets).

The applications 136 may include the following modules (or sets of instructions), or a subset or superset thereof: a contacts module 137 (sometimes called an address book or contact list); a telephone module 138; a video conferencing module 139; an e-mail client module 140; an instant messaging (IM) module 141; a blogging module 142; a camera module 143 for still and/or video images; an image management module 144; a video player module 145; a music player module 146; a browser module 147; a calendar module 148; widget modules 149, which may include weather widget 149-1, stocks widget 149-2, calculator widget 149-3, alarm clock widget 149-4, dictionary widget 149-5, and other widgets obtained by the user, as well as user-created widgets 149-6; widget creator module 150 for making user-created widgets 149-6; search module 151; video and music player module 152, which merges video player module 145 and music player module 146; notes module 153; and/or map module 154; and/or online video module 155.

Examples of other applications 136 that may be stored in memory 102 include other word processing applications, JAVA-enabled applications, encryption, digital rights management, voice recognition, and voice replication.

In conjunction with touch screen 112, display controller 156, contact module 130, graphics module 132, and text input module 134, the contacts module 137 may be used to manage an address book or contact list, including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone 138, video conference 139, e-mail 140, or IM 141; and so forth.

In conjunction with RF circuitry 108, audio circuitry 110, speaker 111, microphone 113, touch screen 112, display controller 156, contact module 130, graphics module 132, and text input module 134, the telephone module 138 may be used to enter a sequence of characters corresponding to a telephone number, access one or more telephone numbers in the address book 137, modify a telephone number that has been entered, dial a respective telephone number, conduct a conversation and disconnect or hang up when the conversation is completed. As noted above, the wireless communication may use any of a plurality of communications standards, protocols and technologies.

In conjunction with RF circuitry 108, audio circuitry 110, speaker 111, microphone 113, touch screen 112, display controller 156, optical sensor 164, optical sensor controller 158, contact module 130, graphics module 132, text input module 134, contact list 137, and telephone module 138, the videoconferencing module 139 may be used to initiate, conduct, and terminate a video conference between a user and one or more other participants.

In conjunction with RF circuitry 108, touch screen 112, display controller 156, contact module 130, graphics module 132, and text input module 134, the e-mail client module 140 may be used to create, send, receive, and manage e-mail. In conjunction with image management module 144, the e-mail module 140 makes it easy to create and send e-mails with still or video images taken with camera module 143.

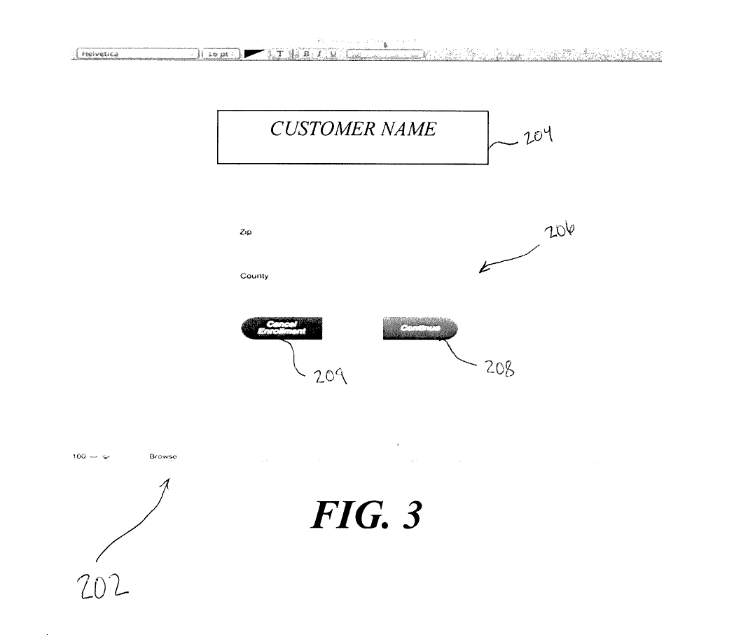

In conjunction with RF circuitry 108, touch screen 112, display controller 156, contact module 130, graphics module 132, and text input module 134, the enrollment module 200 may be used to enroll individuals in programs, such as health insurance programs, as will be described below with reference to FIGS. 3-11. In one embodiment the enrollment module 200 may be implemented as a widget.

In conjunction with RF circuitry 108, touch screen 112, display controller 156, contact module 130, graphics module 132, and text input module 134, the instant messaging module 141 may be used to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages and to view received instant messages.

In conjunction with RF circuitry 108, touch screen 112, display controller 156, contact module 130, graphics module 132, text input module 134, image management module 144, and browsing module 147, the blogging module 142 may be used to send text, still images, video, and/or other graphics to a blog (e.g., the user's blog).

In conjunction with touch screen 112, display controller 156, optical sensor(s) 164, optical sensor controller 158, contact module 130, graphics module 132, and image management module 144, the camera module 143 may be used to capture still images or video (including a video stream) and store them into memory 102, modify characteristics of a still image or video, or delete a still image or video from memory 102.

In conjunction with touch screen 112, display controller 156, contact module 130, graphics module 132, text input module 134, and camera module 143, the image management module 144 may be used to arrange, modify or otherwise manipulate, label, delete, present (e.g., in a digital slide show or album), and store still and/or video images.

In conjunction with touch screen 112, display controller 156, contact module 130, graphics module 132, audio circuitry 110, and speaker 111, the video player module 145 may be used to display, present or otherwise play back videos (e.g., on the touch screen or on an external, connected display via external port 124).

In conjunction with touch screen 112, display system controller 156, contact module 130, graphics module 132, audio circuitry 110, speaker 111, RF circuitry 108, and browser module 147, the music player module 146 allows the user to download and play back recorded music and other sound files stored in one or more file formats, such as MP3 or AAC files.

In conjunction with RF circuitry 108, touch screen 112, display system controller 156, contact module 130, graphics module 132, and text input module 134, the browser module 147 may be used to browse the Internet, including searching, linking to, receiving, and displaying web pages or portions thereof, as well as attachments and other files linked to web pages.

In conjunction with RF circuitry 108, touch screen 112, display system controller 156, contact module 130, graphics module 132, text input module 134, e-mail module 140, and browser module 147, the calendar module 148 may be used to create, display, modify, and store calendars and data associated with calendars (e.g., calendar entries, to do lists, etc.).

In conjunction with RF circuitry 108, touch screen 112, display system controller 156, contact module 130, graphics module 132, text input module 134, and browser module 147, the widget modules 149 are mini-applications that may be downloaded and used by a user (e.g., weather widget 149-1, stocks widget 149-2, calculator widget 149-3, alarm clock widget 149-4, and dictionary widget 149-5) or created by the user (e.g., user-created widget 149-6). A widget may include an HTML (Hypertext Markup Language) file, a CSS (Cascading Style Sheets) file, and a JavaScript file. A widget may also include an XML (Extensible Markup Language) file and a JavaScript file (e.g., Yahoo! Widgets).

In conjunction with RF circuitry 108, touch screen 112, display system controller 156, contact module 130, graphics module 132, text input module 134, and browser module 147, the widget creator module 150 may be used by a user to create widgets (e.g., turning a user-specified portion of a web page into a widget).

In conjunction with touch screen 112, display system controller 156, contact module 130, graphics module 132, and text input module 134, the search module 151 may be used to search for text, music, sound, image, video, and/or other files in memory 102 that match one or more search criteria (e.g., one or more user-specified search terms).

In conjunction with touch screen 112, display controller 156, contact module 130, graphics module 132, and text input module 134, the notes module 153 may be used to create and manage notes, to do lists, and the like.

In conjunction with RF circuitry 108, touch screen 112, display system controller 156, contact module 130, graphics module 132, text input module 134, GPS module 135, and browser module 147, the map module 154 may be used to receive, display, modify, and store maps and data associated with maps (e.g., driving directions; data on stores and other points of interest at or near a particular location; and other location-based data).

In conjunction with touch screen 112, display system controller 156, contact module 130, graphics module 132, audio circuitry 110, speaker 111, RF circuitry 108, text input module 134, e-mail client module 140, and browser module 147, the online video module 155 allows the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In other modes of operation, instant messaging module 141, rather than e-mail client module 140, is used to send a link to a particular online video.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. For example, video player module 145 may be combined with music player module 146 into a single module (e.g., video and music player module 152, FIG. 2). Memory 102 may store a subset of the modules and data structures identified above. Furthermore, memory 102 may store additional modules and data structures not described above.

The device 100 may be a device where operation of a predefined set of functions on the device is performed exclusively through a touch screen 112 and/or a touchpad. By using a touch screen and/or a touchpad as the primary input/control device for operation of the device 100, the number of physical input/control devices (such as push buttons, dials, and the like) on the device 100 may be reduced.

With reference now to FIG. 3-11, various embodiments of graphical user interfaces provided as part of enrollment module 200 operating on mobile device 100 are shown and described. FIG. 3 illustrates an embodiment of a home screen 202, which may include the name or logo 204 of the customer or operator of module 200, as well as location information data entry 206, a continue button 208, and a cancel button 209. Location information 206 may be the location of the potential enrollee, including the enrollee's residence or the enrollee's place of business. Enrollee's location information may be determinative of the available health care plans and, thus, enrollment module 200 may collect this information first as subsequent information collecting interfaces may change based on the location information. Location information input 206 may be accomplished by manual entry of a user of mobile device 100, such as a field agent, or alternatively location information may be automatically populated based on location determining features of mobile device 100, such as GPS module 132.

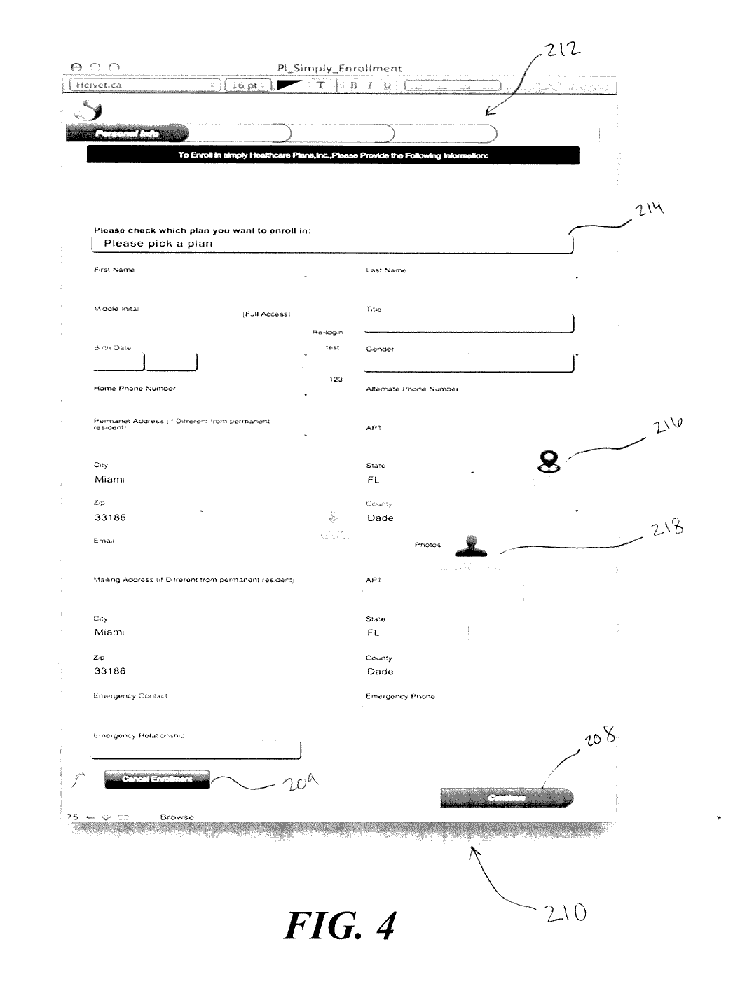

FIG. 4 illustrates an embodiment of a personal information collection screen 210. An agent may manually input the information or, in another embodiment, the enrollee may input either manually or by providing a pre-prepared form, for instance by uploading a pre-prepared form through a remote memory device connected at external port 124 on device 100. Personal information of the enrollee may include the enrollee's name, birthdate, gender, contact information, and location. A progress bar or tabs 212 may be provided to show the enrollee's progress in the enrollment process. In addition to personal information, the enrollee may select which plan 214 they are intending to apply for. Plan 214 may be any known or to be developed plan, policy, or other program, such as an insurance policy. It should be understood, however, that plan 214 is not limited to insurance policies and plan 214 may include any other program requiring enrollment through the collection of information. Available plans 214 for selection may be determined based on the personal information and/or location information provided by the user. As previously discussed, enrollment module 200 may collect location information from location determining modules of the mobile device 100, and such location information may be automatically populated upon request as a result of the agent's activation of a location determining button 216. In an embodiment where the enrollee is seeking to enroll in health insurance, the module 200 may be preloaded with the ability to facilitate in the enrollment in a plurality of health insurance plans. However, the displayed and selectable list of enrollable plans 214 may be determined after inputting of personal and/or location information. In one embodiment, the enrollee would provide location information 206, or the location information would be acquired automatically upon activation of location determining button 216, and the selectable plans 214 would be determined based on which plans are available for enrollees at that location. Additional data or files 218 may be included with the collected information. In one embodiment, photographs of the enrollee may be provided, and such photographs may be taken from the mobile device by camera module 143. Other files such as audio recordings, digital finger prints, retinal scans, or scanned images of documents such as a driver's license or health insurance card are also contemplated as possible files 218 which may be attached.

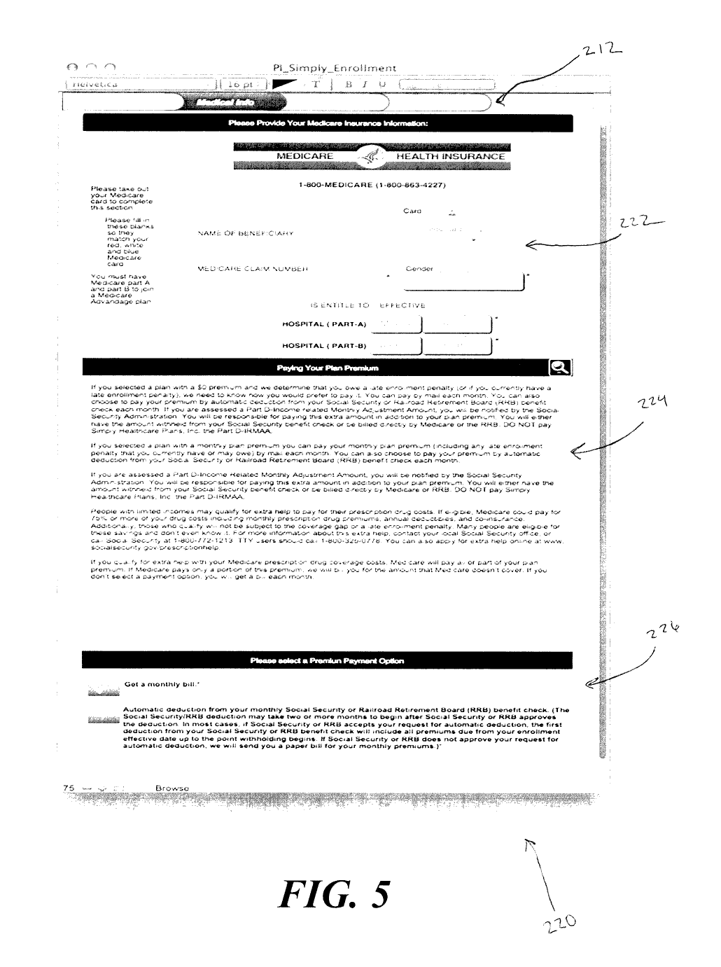

FIG. 5 illustrates a medical information collection screen 220. The illustrated embodiments provide an embodiment for collecting Medicare information as may be utilized for enrollment in Medicare Part D. Accordingly, enrollee's insurance information 222 may be collected including, but not limited to, beneficiary name, policy or claim numbers, gender, and effective dates. Enrollment information 224 may also be provided discussing portions or implications of the selected plan 214 for which the enrollee is seeking enrollment. Payment preference 226 may also be selected by the enrollee, including for instance methods the enrollee's preference to receive periodic bills or participate in an automatic deduction program.

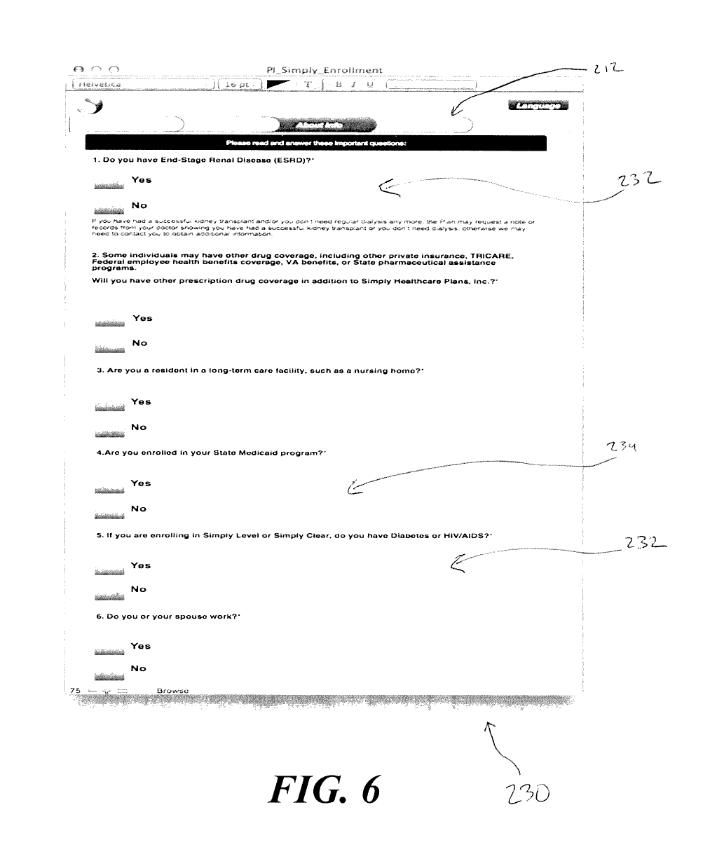

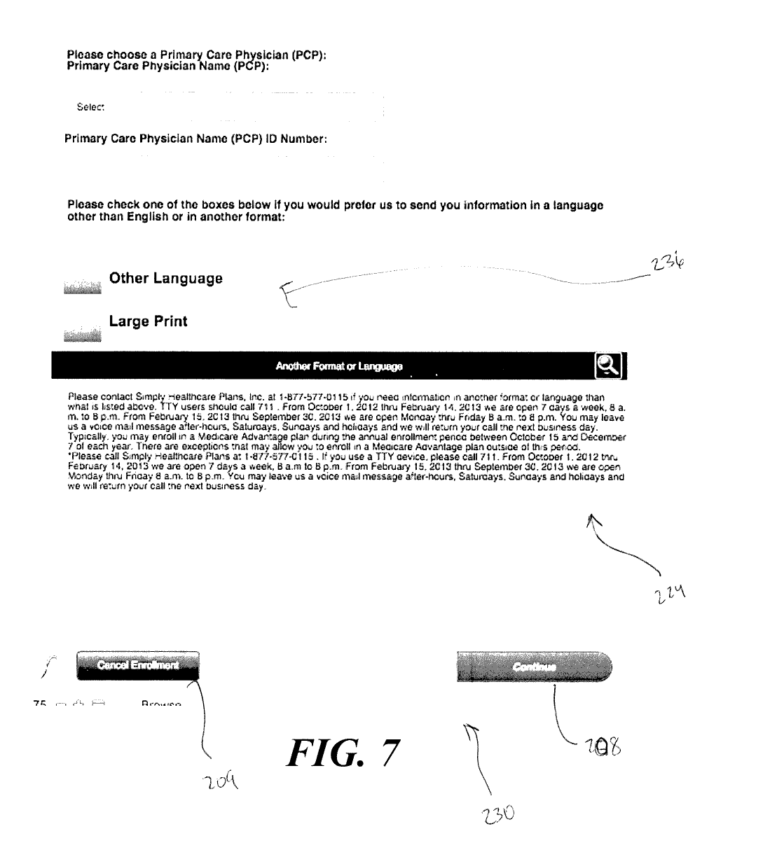

FIGS. 6 and 7 illustrate additional enrollee information screens 230. Enrollment module 200 may include the collection of any additional information which may be determinative of the available plans 214, the cost of the plans, or the scope of coverage associated with the plans. For instance, disease or medical history 232 may be collected from the enrollee regarding their prior health history. Information may also be collected regarding other plans 234 which the enrollee presently participates in, the enrollee's physician information, spousal information, and information regarding and presently received in-patient or out-patient care such as residency at a nursing home. In addition to gathering information, a preferred language 236 may be selected.

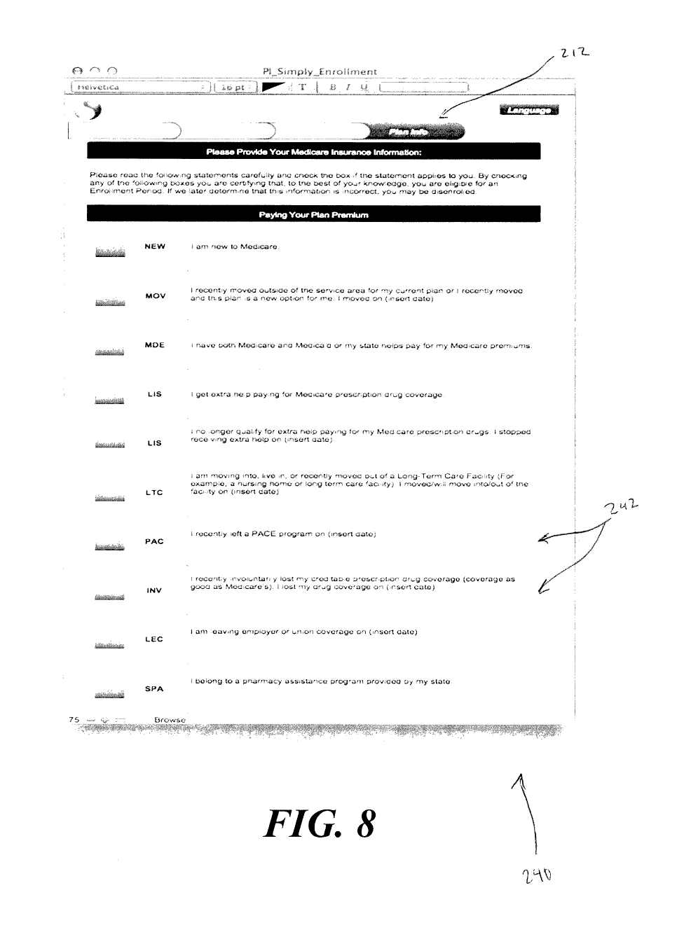

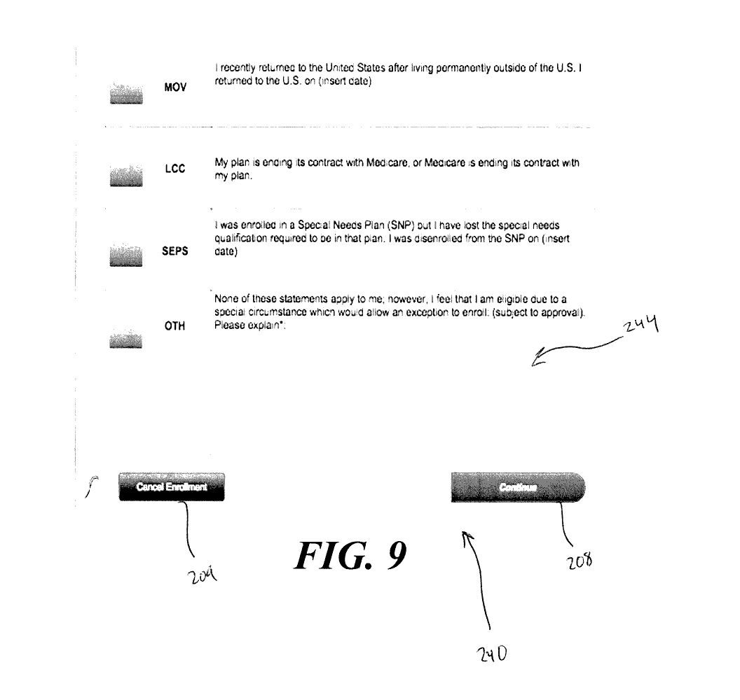

FIGS. 8 and 9 illustrate plan enrollment screens 240. Having collected information regarding the enrollee and related information necessary to proceed with enrollment, enrollment module 200 may ascertain the eligibility basis for the plan the enrollee is attempting to obtain enrollment. Enrollment module 200 may cross reference collected information with possible eligibility basis for plans which the enrollee may be able to enroll, and present the options 242 to the enrollee. The enrollee may also manually enter an enrollment justification 244, thereby providing why the enrollee may be entitled to enrollment even if none of the automatically populated options are applicable.

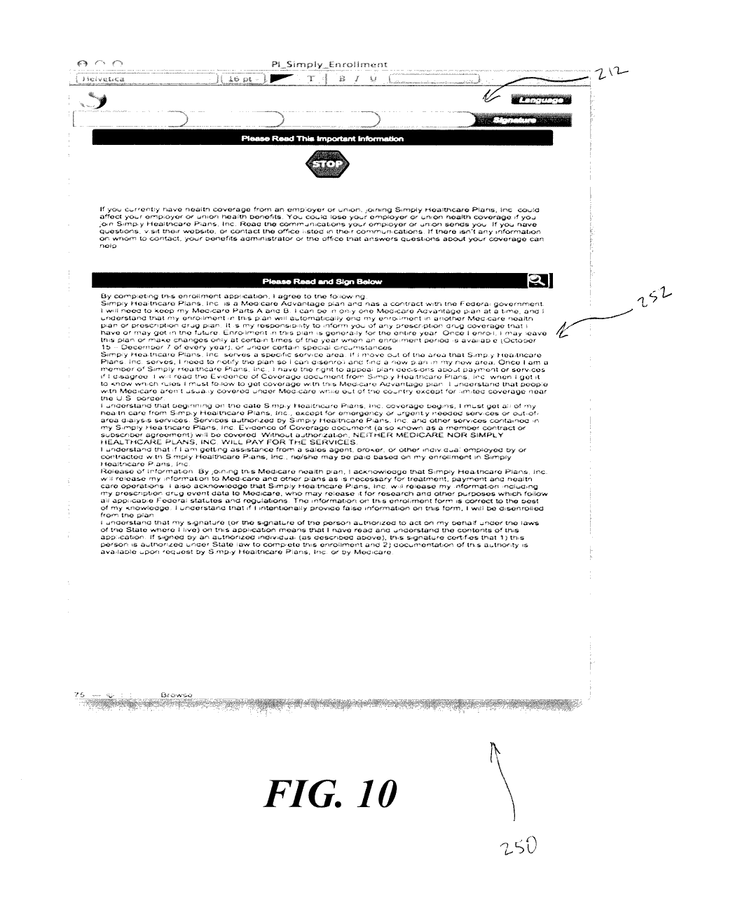

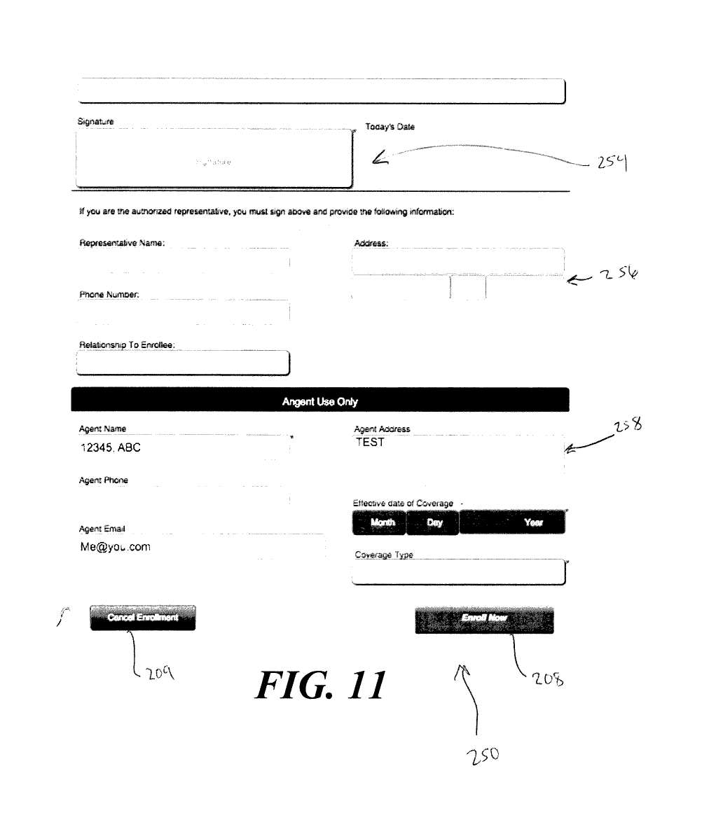

FIGS. 10 and 11 illustrate a confirmation or signature screen 250. Having collected all information and explanations regarding the enrollee's application, the enrollee may finish the information acquisition step of the enrollment process by reviewing and signing an enrollment contract 252. A digital signature block 254 may be provided, and the enrollee may type their digital signature, draw their signature using the capabilities mobile device 100, or attached a file containing an image of their signature. In the event an authorized representative of enrollee completes the enrollment process, the representative information 256 may also be entered. The agent operating mobile device 100 and enrollment module 200 may also provide the agent information 258, which in some embodiments may be prepopulated based on the agent's log-in credentials. Dates and times may be automatically obtained from a clock provided on mobile device 100.

Security features may also be included in enrollment module 200, including but not limited to password or other credential input requirements and automatic timed log outs of the application. Mobile device 100 may also be restricted in terms of its ability to be remotely accessible. For instance, while mobile device 100 may be configured for receipt of confirmation messages, such receivers may be extremely limited or even entirely eliminated, so long as a confirmation message receipt is not included in such an embodiment.

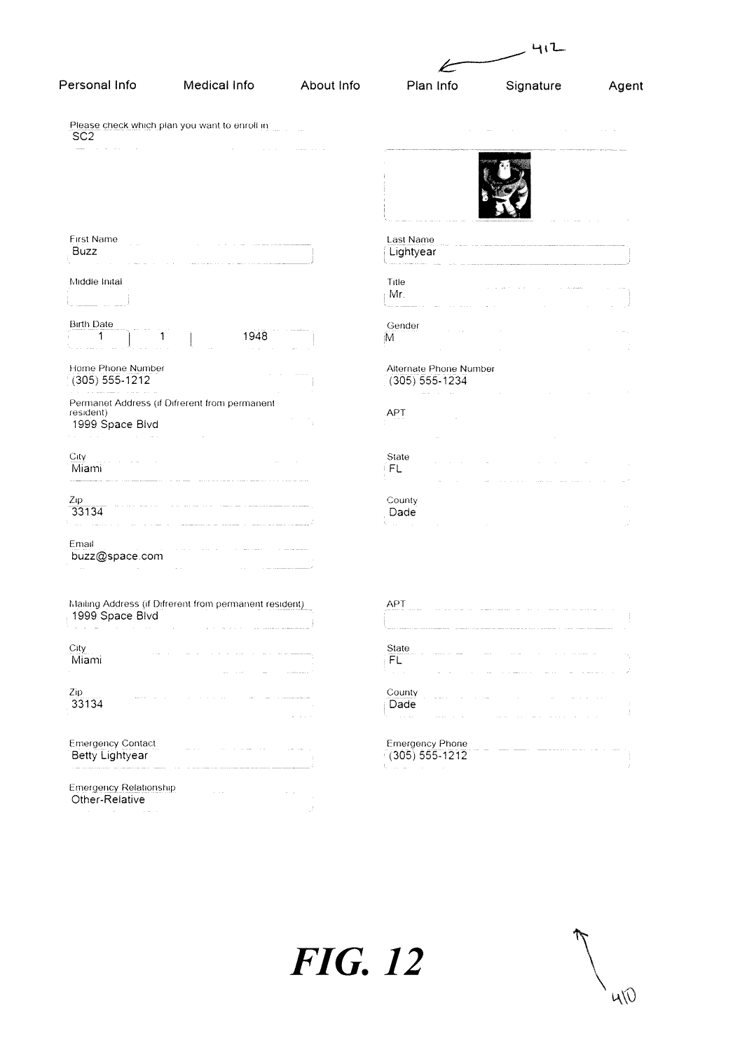

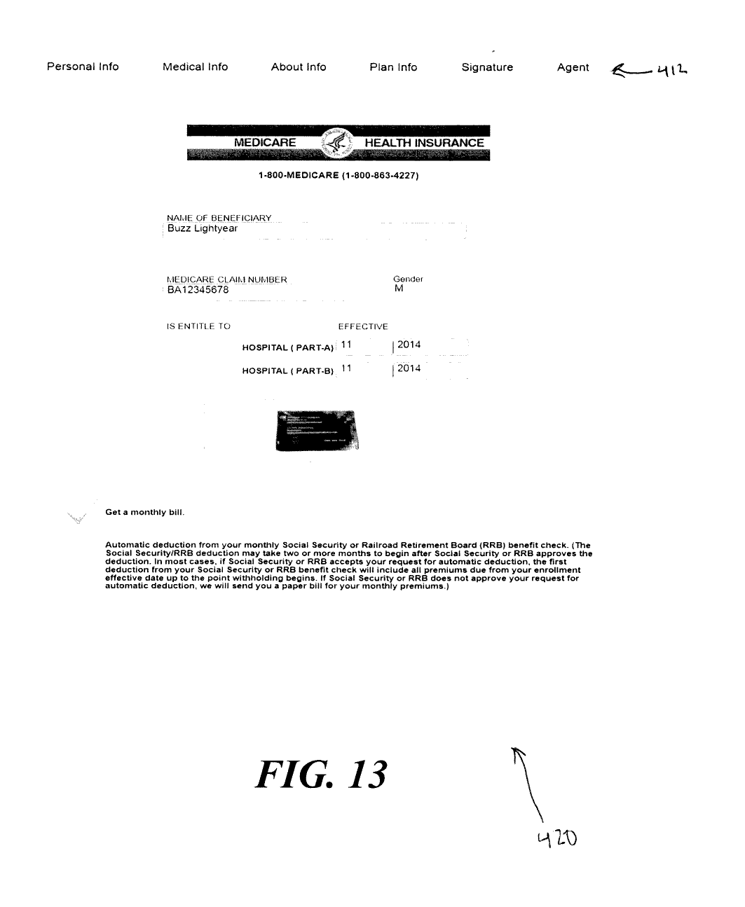

With reference now to FIGS. 12-14, various embodiments of graphical user interfaces provided as part of an administrative module 300 operating on a remote administrative computer 400, as further described herein. FIG. 12 illustrates a personal information review screen 410. Accordingly, an administrator may be able to review the enrollee information collected by enrollment module 200 operating on mobile device 100. Further, FIG. 13 illustrates a medication information review screen 420. The various data, files, and information collected by toggled by the administrator for review by selecting information review tabs 412.

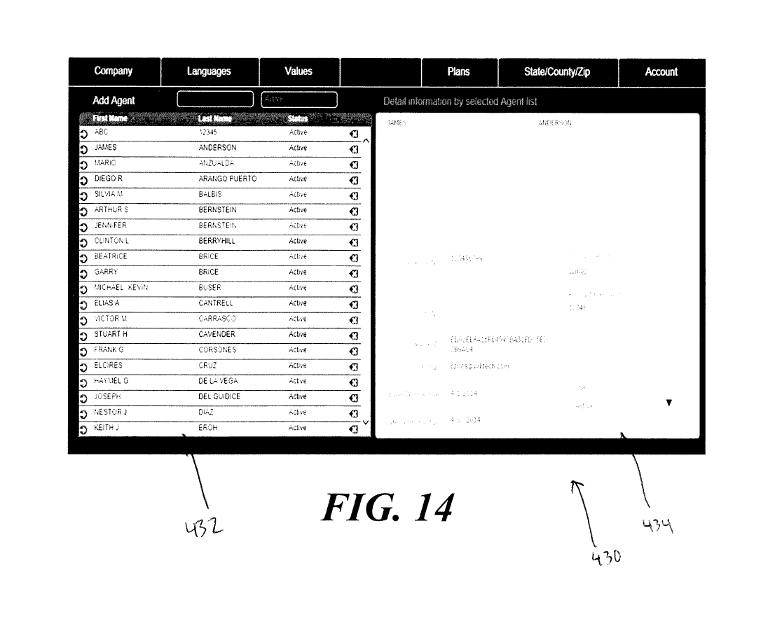

FIG. 14 illustrates a database screen 430. Here, an administrator may be able to view agents operating to collect enrollee information and view agent information as well as enrollment information associated with the agent. Administrators may be able to view a list 432 of agents, or alternative may sort the database based enrollee information, date, or other sortable categories. Additionally, administrators may open files identified in list 432 or, alternatively, may preview a subset of previewable information in a preview window 434. Administrators can also amend information such as adding agents, changing security settings, editing of the enrollment information database, and generation of reports based statistical analysis of collected information.

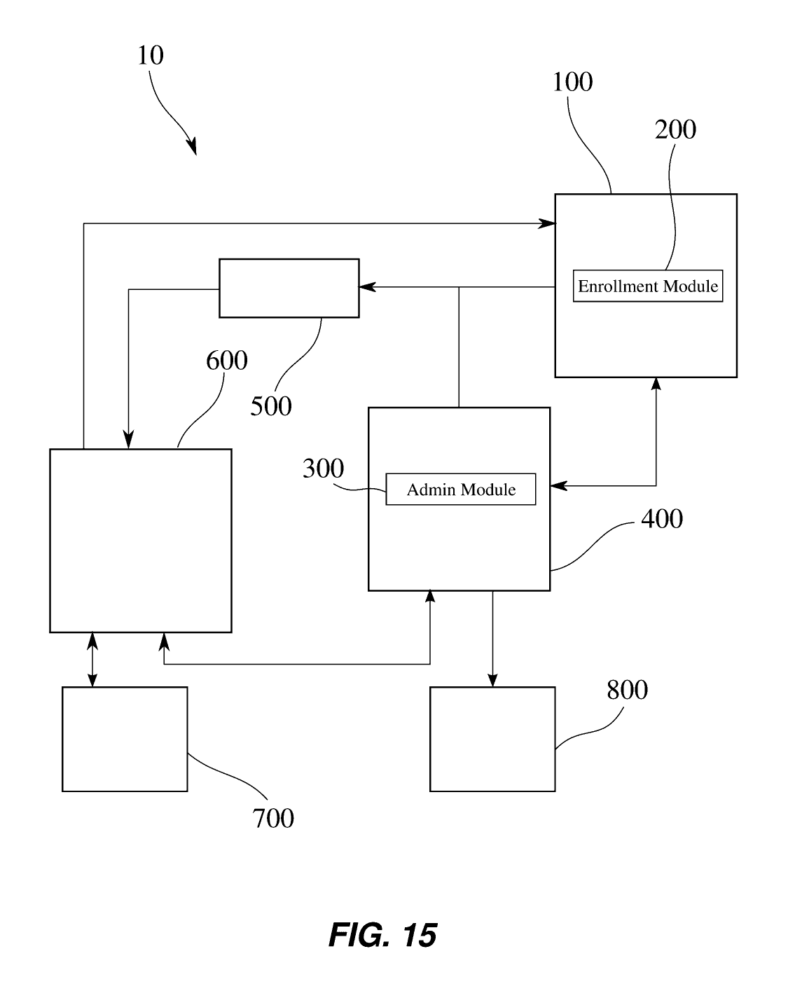

With reference now to FIG. 15, an embodiment of a system 10 for enrolling individuals in programs, such as an insurance program, is shown. The system may include mobile device 100 including enrollment module 200, an administrator computer system 400 including administrator module 300 and a first local area network, a second local area network 500, a cloud computer system 600, a remote server 700, and a submission computer system 800. It should be understood and appreciated that computer systems 400, 600 may include any component described in association with mobile device 100, along with any components typically included and associated with computer systems, such as known or to be developed processors, storage or memory, servers, output devices, input devices, transmitter devices, and receiver devices. It should also be understood and appreciated that first and second local area networks may include computer systems as part of their network architecture.

Mobile device 100 and enrollment module 200 are described above and may be utilized to collect enrollment information. Upon collection, enrollment information may be transmitted to second local area network 500. Transmission may occur wirelessly by, for instance, a Wi-Fi connection, 3G or 4G telecommunications, or a wide area network (WAN). Enrollment module 200 may encrypt enrollment prior to transmission. Encryption may occur in accordance with the Advanced Encryption Standard (AES), which is known to be a symmetric-key algorithm, or alternatively any other known or to be developed encryption method. Additionally, the step of encryption may further include utilization of a secure has algorithm such as SHA-2. A secure connection may be established between mobile device 100 and cloud computer system 500 via secure sockets layer in order to prevent, or at least, tampering with the transmission of data. Second local area network may include a firewall provided prior to the network's receipt of the enrollment information. After passing through the firewall, decryption of the enrollment data may occur.

After receipt of decrypted enrollment information, second local area network may transmit the decrypted enrollment data to cloud computer system 600, which in turn may store and retrieve enrollment data from remote server 700. Storage of data or remote server 700 may be encrypted in accordance with federal information processor standards. In embodiment, remoter server 700 is a Structured Query Language (SQL) server.

Transmission of enrollment data between mobile device 100 and cloud computer system 600 via second local area network 500 will be one-way in preferred embodiments in order to dissuade tampering of enrollment information. Indeed, in some embodiments enrollment module 200 will automatically delete or erase the enrollment information after it has been transmitted in order to further prevent tampering or misappropriation of the information. In another embodiment, a confirmation message, which may be an electronic mail message or an SMS message, may be transmitted from computer cloud system 600 to mobile device 100 upon confirmation of decrypted enrollment information. The confirmation message may also be sent after cloud computer 600 authenticates the enrollment information, for instance by confirmation of a successful decryption or any known or to be discovered data authentication method. In some embodiments, second local area network 500 may send the confirmation message, and in additional embodiments both second local area network 500 and cloud computer system 600 send confirmation messages to mobile device 100. Such confirmation messages may permit the agent to confirm with enrollee that the enrollment information has been successfully transmitted.

In the illustrated embodiment, cloud computer system 600 is in communication with first local area network of the administrator computer network 400. In additional embodiments, enrollment information is decrypted and stored on second local area network and transmitted directly to first local area network, and while in further embodiments second local area network and cloud computer system may be all together eliminated such that enrollment information is sent directly to administrative computer system 400. However, in embodiments where system 10 includes first and second local area networks along with an independent cloud computer system, enrollment data may be further verified and checked at independent steps in the enrollment process.

Second local area network may include a server for reporting and backing up enrollment information collected from one or more mobile devices 100, as well as a network drive and a processor for generating reports based on enrollment information, and reviewing collected information data. The review of enrollment information may include authentication of enrollee's eligibility to enroll in the selected plan or policy. After processing of enrollment information, second local area network may transmit the enrollment information to a policy provider via transmission to the provider computer system 800.

In a further embodiment, mobile device 100, second local area network 500, or cloud computer system 600 may directly connect to an insurance or plan provider in order to provide real-time confirmation of enrollee eligibility for various plans. In this regard, an agent operating mobile device 100 may know very quickly whether enrollee will be able to attain the desired plan while the agent is still on site with the enrollee. In these embodiments, a batch eligibility query (BEQ) process or MARx online query (M232 screen) are contemplated as possible process(es) for achieving an on-site query of enrollee eligibility as part of enrollment module 200. If the enrollee is determined to be ineligible, the agent may still continue with the enrollment process but may be required to submit additional evidence to show the enrollee's eligibility for a plan. For instance, if an enrollee is determined to be not entitled for Medicare benefits while applying for Medicare Part A or Part B enrollment, the enrollee may be required to submit their Medicare ID card and supplemental evidence of entitlement to benefits.

Administrator module 300 is illustrated as part of the administrative computer system 400 which may be included in the first area network. However, it should be understood and appreciated that the administration module 300 may be operated on a separate and distinct computer system. Administrator module 300 may be operable to facilitate the administration and accessibility of system 10. For instance, administrator module 300 may be operable to generate access privileges for agents utilizing enrollment module 200 as well as administrators operating administer module 300. These privileges may be further associated with user specific passwords, pins, or other identification information to ensure only authorized and trained employees are operating modules 200, 400. Administrative module 400 may also be utilized for review and manipulation of enrollment data, as shown and described in embodiments of FIGS. 12-14. Administrator module may also be utilized to audit agent and enrollment information. Auditing of privilege information, data transmission records, and enrollment information may be a feature helpful to detect possible misuse of system 10.

The descriptions set forth above are meant to be illustrative and not limiting. Various modifications of the embodiments, in addition to those described herein, will be apparent to those skilled in the art from the foregoing description. Such modifications are also intended to fall within the scope of the concepts described herein. Each patent, patent application and publication cited or described in this document are hereby incorporated herein by reference, in their entireties.

The foregoing description of possible implementations consistent with the present disclosure does not represent a comprehensive list of all such implementations or all variations of the implementations described. The description of some implementation should not be construed as an intent to exclude other implementations. For example, artisans will understand how to implement the embodiments in many other ways, using equivalents and alternatives that do not depart from the scope of the disclosure. Moreover, unless indicated to the contrary in the preceding description, none of the components described in the implementations are essential to the embodiments disclosed. It is thus intended that the embodiments be considered as illustrative, with a true scope and spirit of the disclosure being indicated by the following claims.

What is claimed:

1. A system for enrolling individuals in an insurance policy, the system comprising:
a mobile device for collecting, transmitting, and encrypting enrollment information;
a local area network for receiving and decrypting enrollment information;
a cloud computer system for receiving and storing the decrypted enrollment information; and
an additional local area network for processing the enrollment information.
